(19) United States
(12) Patent Application Publication
(10) Pub. No.: US 2011/0230103 A1
(43) Pub. Date: Sep. 22, 2011

(54) POWER DISTRIBUTION UNIT INCLUDING WIRE CIRCUIT

(75) Inventor: KUEI-CHIH HOU, Tu-Cheng (TW)

(73) Assignee: HON HAI PRECISION INDUSTRY CO., LTD., Tu-Cheng (TW)

(21) Appl. No.: 12/825,344

(22) Filed: Jun. 29, 2010

(30) Foreign Application Priority Data
Mar. 17, 2010 (TW) 99107728

(51) Int. Cl. H01R 24/00

(52) U.S. Cl. 439/660

(57) ABSTRACT

A power distribution unit includes a first power interface, a wire circuit, connector, and a plurality of output sockets electrically connected in series. The first power interface is configured for connecting to an external main power supply. The plurality of output sockets are configured for providing an output voltage. The wire circuit is connected between the first power interface and the connector to enable that the output voltage of each output socket is in range of 180V-240V without changing the connection between each output socket and the connector.

### BACKGROUND

1. Technical Field

The present disclosure relates to power distribution units, and more particularly, to power distribution units including a wire circuit corresponding to international electrical standards.

2. Description of Related Art

Power distribution units are widely used to provide power for all kinds of different electrical load devices such as computers, microwave ovens, televisions or light source devices. A typical power distribution unit includes a power interface for receiving an external power supply and a plurality of output ports for providing the power supply to the electrical load devices. However, different countries have different main supply standards in single-phase power supplies and also three-phase single-phase power supplies. Thus, a typical power distribution unit providing output voltage in desired range of 180V-240V is needed to be used in different countries.

Therefore, a new power distribution unit is desired to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a circuit diagram of a power distribution unit according to a first embodiment of the present disclosure.

FIG. 2 is a circuit diagram of a power distribution unit according to a second embodiment of the present disclosure.

FIG. 3 is a circuit diagram of a power distribution unit according to a third embodiment of the present disclosure.

### DETAILED DESCRIPTION

Reference will now be made to the drawings to describe various embodiments of the present disclosure in detail, wherein like numerals refer to like elements throughout.

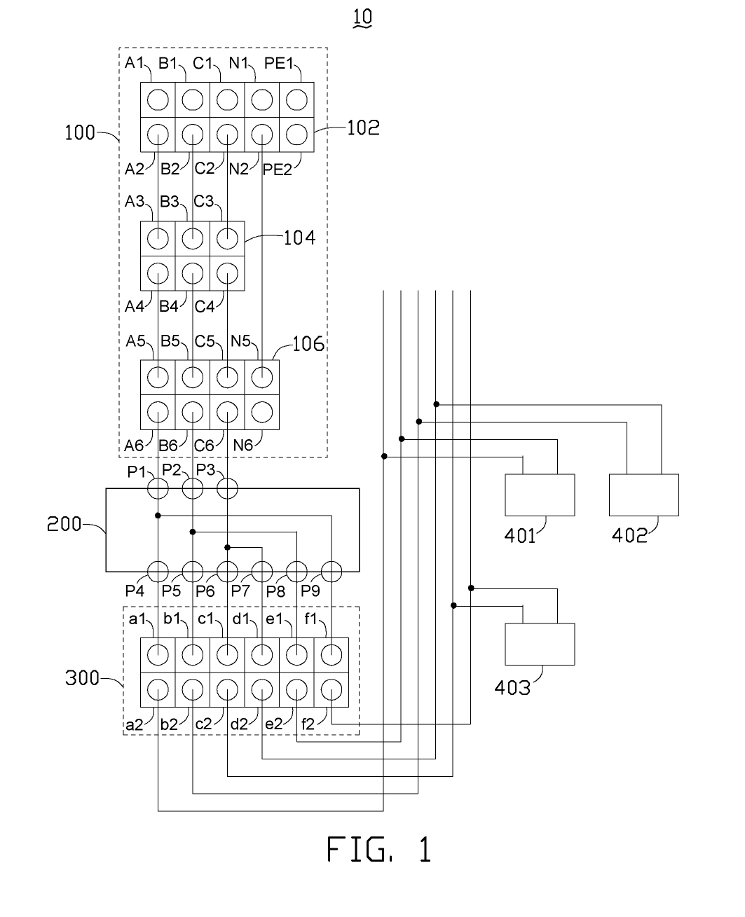

Referring to FIG. 1, a power distribution unit 10 according to a first embodiment of the present disclosure is shown. The power distribution unit 10 includes a power interface 100, a first wire circuit 200, a connector 300, a first output socket 401, a second output socket 402, and a third output socket 403.

The power interface 100 includes a first interface 102, a leakage protection switch 104 and a second interface 106.

The first interface 102 includes a first wire connector A1-A2, a second wire connector B1-B2, a third wire connector C1-C2, a fourth wire connector N1-N2, and a fifth wire connector PE1-PE2 electrically insulated from each other. As shown in FIG. 1, the five wire connectors A1-A2, B1-B2, C1-C2, N1-N2 and PE1-PE2 of the first interface 102 are arranged in that order from left to right.

The first wire connector A1-A2 includes a first connecting port A1 and an opposite second connecting port A2. The second wire connector B1-B2 includes a first connecting port B1 and an opposite second connecting port B2. The third wire connector C1-C2 includes a first connecting port C1 and an opposite second connecting port C2. The fourth wire connector N1-N2 includes a first connecting port N1 and an opposite second connecting port N2. The fifth wire connector PE1-PE2 also includes a first connecting port PE1 and an opposite second connecting port PE2. That is, each wire connector of the first interface 102 includes a pair of opposite connecting ports, namely a first connecting port X1 and a second connecting port X2 (X denotes one of the symbols A. B, C, N and PE). Pertaining to each wire connector of the first interface 102, the first connecting port X1 electrically connects the second connecting port X2 via an internal wire (not shown). The first connecting ports X1 of all the five wire connectors A1-A2, B1-B2, C1-C2, N1-N2 and PE1-PE2 are arranged in that order at one side of the first interface 102. The second connecting ports X2 of all the five wire connectors A1-A2, B1-B2, C1-C2, N1-N2 and PE1-PE2 are arranged in that order at the other side of the first interface 102.

Similarly, the leakage protection switch 104 includes a first wire connector A3-A4, a second wire connector B3-B4, and a third wire connector C3-C4. The wire connectors A3-A4, B3-B4, C3-C4 are electrically insulated from each other. Each wire connector of the current leakage protection switch 104 includes a pair of opposite connecting ports, namely a first connecting port Y3 and a second connecting port Y4 (Y denotes one of the symbols A, B and C). Pertaining to each wire connector of the leakage protection switch 104, the first connecting port Y3 electrically connects the second connecting port Y4 via an internal leakage protection circuit (not shown). The leakage protection switch 104 can automatically cut off the electrically conductive connection between the first connecting port Y3 and the second connecting port Y4 when an over-current flows through one of the corresponding wire connectors A3-A4, B3-B4 and C3-C4.

Similarly, the second interface 106 includes a first wire connector A5-A6, a second wire connector B5-B6, a third wire connector C5-C6, and a fourth wire connector N5-N6. The four wire connectors A5-A6, B5-B6, C5-C6 and N5-N6 are electrically insulated from each other. Each wire connector of the second interface 106 includes a pair of opposite connecting ports, namely a first connecting port Z5 and a second connecting port Z6 (Z denotes one of the symbols A, B, C and N). Pertaining to each wire connector of the second interface 106, the first connecting port Z5 electrically connects the second connecting port Z6 via an internal wire (not shown).

The second connecting ports A2, B2 and C2 of the first interface 102 respectively connect to the first connecting ports A3, B3 and C3 of the leakage protection switch 104 such that the first wire connector A1-A2, the wire connector B1-B2, and the third wire connector C1-C2 of the first interface 102 respectively connect to the first wire connector A3-A4, the second wire connector B3-B4, and the third wire connector C3-C4 of the leakage protection switch 104.

The second connecting ports A4, B4 and C4 of the leakage protection switch 104 respectively connect to the first connecting ports A5, B5 and C5 of the second interface 106 such that the first wire connector A3-A4, the second wire connector B3-B4, and the third wire connector C3-C4 of the leakage protection switch 104 respectively connect to the first wire connector A5-A6, the second wire connector B5-B6, and the third wire connector C5-C6 of the second interface 106.

The second connecting port N2 of the fourth wire connector N1-N2 of the first interface 102 is electrically connected to the first connecting port N5 of the fourth wire connector N5-N6 of the second interface 106.

The first wire circuit 200 includes a first input port P1, a second input port P2, and a third input port P3 arranged in that order in row at one side of the first wire circuit 200. The first wire circuit 200 further includes a first output port P4, a second output port P5, a third output port P6, a fourth output port P7, a fifth output port P8, and a sixth output port P9 arranged in that order in row at the other side of the first wire circuit 200. The first input port P1 is electrically connected to the first and the sixth output ports P4 and P9. The second input port P2 is electrically connected to the second and the fifth output ports P5 and P8. The third input port P3 is electrically connected to the third and the fourth output ports P6 and P7.

Similar to the first interface 102, the connector 300 includes a first wire connector a1-a2, a second wire connector b1-b2, a third wire connector c1-c2, a fourth wire connector d1-d2, a fifth wire connector e1-e2, and a sixth wire connector f1-f2 are electrically insulated from each other. As shown in FIG. 1, the wire connectors a1-a2, b1-b2, c1-c2, d1-d2, e1-e2, and f1-f2 of the connector 300 are arranged in that order from left to right. Each wire connector of the connector 300 includes a pair of opposite connecting ports, namely a first connecting port O1 and a second connecting port O2 (O denotes one of the symbols a. b, c, d, e and f). Pertaining to each wire connector of connector 300, the first connecting port O1 is electrically connected to the second connecting port O2 via an internal wire (not shown).

The first connecting ports a1, b1, c1, d1, e1 and f1 of the connector 300 are respectively connected to the first output port P4, the second output port P5, the third output port P6, the fourth output port P7, the fifth output port P8, and the sixth output port P9 of the first wire circuit 200. Thus, the first wire connector a1-a2, the second wire connector b1-b2, the third wire connector c1-c2, the fourth wire connector d1-d2, the fifth wire connector e1-e2, and the sixth wire connector f1-f2 of the connector 300 respectively connect to the first output port P4, the second output port P5, the third output port P6, the fourth output port P7, the fifth output port P8, and the sixth output port P9 of the first wire circuit 200.

Each of the first output socket 401, the second output socket 402, and the third output socket 403 includes two power input terminals (not labeled). The two power input terminals of the first output socket 401 are respectively connected to the second connecting ports a2 and b2 of the first and the second wire connectors a1-a2 and b1-b2. The two power input terminals of the second output socket 402 are respectively connected to the second connecting ports c2 and d2 of the third and the fourth wire connectors c1-c2 and e1-e2. The two power input terminals of the third output socket 403 are respectively connected to the second connecting ports e2 and f2 of the fifth and the sixth wire connectors e1-e2 and f1-f2.

When the power distribution unit 10 is electrically connected to a main power supply such as a three-phase five-wire power via the first interface 102, for example. The first connecting ports A1, B1 C1, N1 and PE1 of the first, the second, the third, the fourth and the fifth wire connectors A1-A2, B1-B2, C1-C2, N1-N2 and PE1-PE2 of the first interface 102 are respectively connected to a first phase wire, a second phase wire, a third phase wire, a neutral wire, and a ground wire of the three-phase five-wire power. A voltage between the two power input terminals of each output sockets 401, 402 or 403 is approximately equal to 208V. Therefore each output sockets 401, 402 or 403 can provide the 208V voltage to an electrical load device.

In operation, because the first input port P1, the second input port P2, and the third input port P3 of first wire circuit 200 spatially correspond to the second connecting ports A6, B6 and C6 of the second interface 106 of the power interface 100. The first wire circuit 200 can easily connect to the second interface 106 of the power interface 100 and time for distinguishing an internal layout of the power interface 100 to prevent a connecting mistake is saved. Furthermore, because the internal layout of the first wire circuit 200 can be adjusted according to different standard external power supplies, an output voltage in a required range of 180V-240V of each output socket 401, 402 or 403 can easily be provided without changing the connection between each output socket 401, 402 or 403 and the connector 300.

In one alternative embodiment, when both the leakage protection switch 104 and second interface 106 are omitted, the first input port P1, the second input port P2, and the third input port P3 of the first wire circuit 200 are respectively connected to the second connecting ports A2, B2 and C2 of the first interface 102 of the power interface 100. When only the second interface 106 is omitted, the first input port P1, the second input port P2, and the third input port P3 of first wire circuit 200 are respectively connected to the second connecting ports A4, B4 and C4 of the leakage protection switch 104.

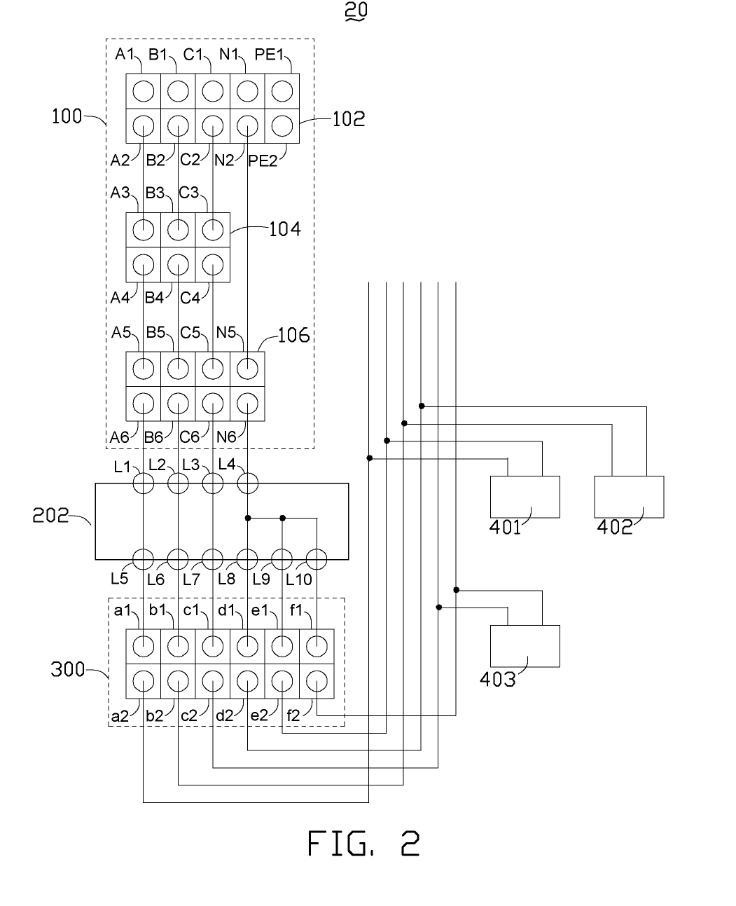

Referring to FIG. 2, a power distribution unit 20 according to a second embodiment of the present disclosure is shown. The power distribution unit 20 differs from the power distribution unit 10 in that a second wire circuit 202 includes a first input port L1, a second input port L2, a third input port L3, and a third input port L4 arranged in that order in row at one side of the second wire circuit 202. The second wire circuit 202 further includes a first output port L5, a second output port L6, a third output port L7, a fourth output port L8, a fifth output port L9, and a sixth output port P10 arranged in that order in row at the other side of the second wire circuit 202.

The first input port L1 connects the first output port L5. The second input port L2 connects the second output port L6. The third input port connects the third output port L8. The fourth input port L4 connects the fourth, the fifth, and the sixth output ports L8, L9 and L10. The fourth input port L4 is also connected to the second connecting port N2 of the fourth wire connector N1-N2 of the first interface 102 via the fourth wire connector N5-N6 of the second interface 106.

In operation, when the power distribution unit 20 is electrically connected to a main power supply, such as a three-phase five-wire power via the first interface 102, for example. The first connecting ports A1, B1 C1, N1 and PE1 of the first, the second, the third, the fourth and the fifth wire connectors A1-A2, B1-B2, C1-C2, N1-N2 and PE1-PE2 of the first interface 102 are respectively connected to a first phase wire, a second phase wire, a third phase wire, a neutral wire, and a ground wire of the three-phase five-wire power. A voltage between the two power input terminals of each output sockets 401, 402 or 403 is approximately equal to 230V. Therefore each output sockets 401, 402 or 403 can provides the 230V voltage to an electrical load device.

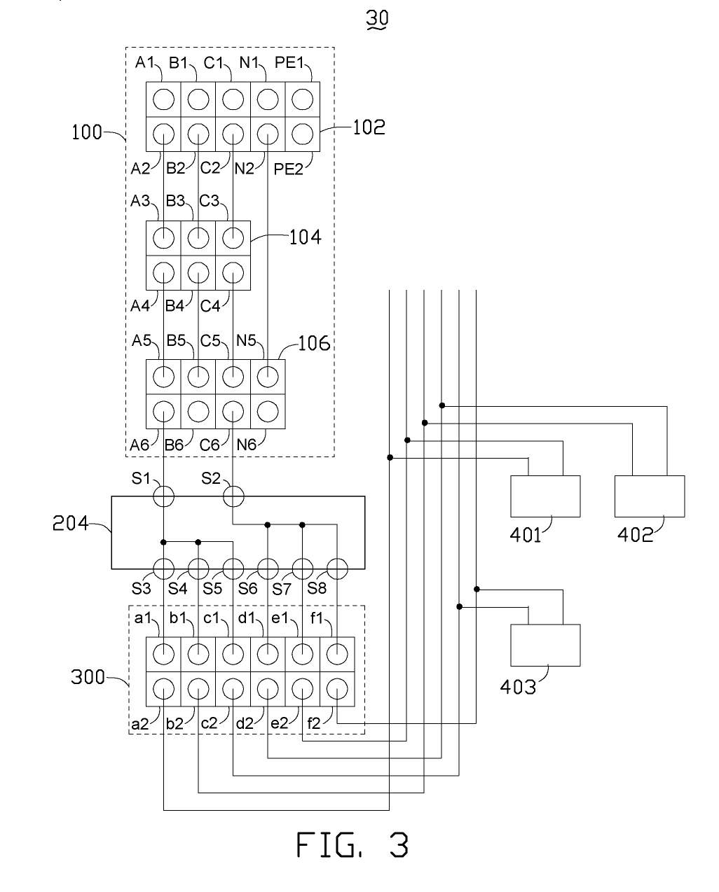

Referring to FIG. 3, a power distribution unit 30 according to a third embodiment of the present disclosure is shown. The power distribution unit 30 differs from the power distribution unit 10 in that a third wire circuit 204 includes a first input port S1 and a second input port S2 arranged in that order in row at one side of the third wire circuit 204. The third wire circuit 204 further includes a first output port L3, a second output port L4, a third output port L5, a fourth output port L6, a fifth output port L7, and a sixth output port P8 arranged in that order in row at the other side of the third wire circuit 204. The first input port S1 connects to the first, the second and the third output ports S3, S4 and S5. The second input port S2 connects to the fourth, the third and the fourth output ports S6, S7 and S8. The first input port S1 also connects to the second connecting port A6 of the first wire connector A5-A6 of the second interface 106. The second input port S2 also connects to the second connecting port C6 of the third wire connector C5-C6 of the second interface 106.

In operation, when the power distribution unit 30 is electrically connected to a main power supply such as a single-phase three-wire power via the first interface 102, for example. The first connecting ports A1, C1 and PE1 of the first, the third and the fifth wire connectors A1-A2, C1-C2 and PE1-PE2 of the first interface respectively connect to a live wire, a neutral wire and a ground wire of the single-phase three-wire power. A voltage between the two power input terminals of each output sockets 401, 402 or 403 is approximately equal to 220V. Therefore each output sockets 401, 402 or 403 can provide the 220V voltage to an electrical load device.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A power distribution unit, comprising:
a first power interface;
a wire circuit;
connector, and
a plurality of output sockets, the first power interface, the wire circuit, the connector, and the output sockets being electrically connected in series in that order;
wherein the first power interface is configured for connecting to an external main power supply, the plurality of output sockets are configured for providing an output voltage, and the wire circuit is connected between the first power interface and the connector to enable the output voltage of each output socket to be in range of 180V-240V without changing the connection between each output socket and the connector.

2. The power distribution unit of claim 1, wherein the first interface comprises a first wire connector, a second wire connector, a third wire connector, a fourth wire connector, and a fifth wire connector arranged in that order and electrically insulated from each other, each wire connector of the first interface comprises a first connecting port and an opposite second connecting port electrically connected the first connecting port.

3. The power distribution unit of claim 2, further comprising a leakage protection switch, the leakage protection switch comprising a first wire connector, a second wire connector, and a third wire connector arranged in that order and electrically insulated from each other, each wire connector of the leakage protection switch comprising a first connecting port and an opposite second connecting port electrically connected the first connecting port, wherein the first connecting ports of the first, the second and the third wire connectors of the leakage protection switch are respectively connected to the second connecting ports of the first, the second and the third wire connectors of the first interface.

4. The power distribution unit of claim 3, further comprising a second interface comprising a first wire connector, a second wire connector, a third wire connector, and a fourth wire connector arranged in that order and electrically insulated from each other, wherein each wire connector of the second interface comprises a first connecting port and an opposite second connecting port electrically connected the first connecting port, the first connecting ports of the first, the second and the third wire connectors of the second interface are respectively connected to the second connecting ports of the first, the second and the third wire connectors of the leakage protection switch, and the first connecting port of the fourth wire connector of the second interface is connected to the second connecting port of the fourth wire connector of the first interface.

5. The power distribution unit of claim 4, wherein the first connecting ports of the first to five wire connectors are respectively connected to a first phase wire, a second phase wire, a third phase wire, a neutral wire, and a ground wire of a three-phase five-wire power.

6. The power distribution unit of claim 5, wherein the wire circuit comprises a first input port, a second input port, and a third input port arranged in that order in row at one side of the wire circuit, the wire circuit further comprises a first output port, a second output port, a third output port, a fourth output port, a fifth output port, and a sixth output port arranged in that order in row at the other side of the first wire circuit, wherein the first input port electrically is connected to the first and the sixth output ports, the second input port electrically is connected to the second and the fifth output ports, and the third input port electrically is connected to the third and the fourth output ports.

7. The power distribution unit of claim 6, wherein the first, the second and the third input ports of the wire circuit are respectively connected to the second connecting ports of the first, the second and the third wire connectors of the second interface.

8. The power distribution unit of claim 7, wherein the connector comprises a first wire connector, a second wire connector, a third wire connector, a fourth wire connector, a fifth wire connector, and a sixth wire connector arranged in that order and electrically insulated from each other, each wire connector of the connector comprises a first connecting port and a second connecting port electrically connected the first connecting port.

9. The power distribution unit of claim 8, wherein the first connecting ports of the connector are respectively connected to the first output port, the second output port, the third output port, the fourth output port, the fifth output port, and the sixth output port of the wire circuit.

10. The power distribution unit of claim 9, wherein each socket comprises two power input terminals, the plurality of output sockets are correspondingly connected to the first to sixth wire connectors of the connector, a voltage between the two power input terminals of each output sockets is approximately equal to 208V.

11. The power distribution unit of claim 5, wherein the wire circuit comprises a first input port, a second input port, a third input port, and a fourth input port arranged in that order in row at one side of the wire circuit, the wire circuit further comprises a first output port, a second output port, a third output port, a fourth output port, a fifth output port, and a sixth output port arranged in that order in row at the other side of the first wire circuit, wherein the first input port is connected the first output port, the second input port is connected the second output port, the third input port is connected the third output port, the fourth input port is connected the fourth, the fifth, and the sixth output ports.

12. The power distribution unit of claim 11, wherein the first, the second and the third input ports of the wire circuit are respectively connected to the second connecting ports of the first, the second and the third wire connectors of the second interface, the fourth input port is connected to the second connecting port of the fourth wire connector of the second interface.

13. The power distribution unit of claim 12, wherein the connector comprises a first wire connector, a second wire connector, a third wire connector, a fourth wire connector, a fifth wire connector, and a sixth wire connector arranged in that order and electrically insulated from each other, each wire connector of the connector comprises a first connecting port and a second connecting port electrically connected the first connecting port.

14. The power distribution unit of claim 13, wherein the first connecting ports of the connector are respectively connected to the first output port, the second output port, the third output port, the fourth output port, the fifth output port, and the sixth output port of the wire circuit.

15. The power distribution unit of claim 14, wherein each socket comprises two power input terminals, the plurality of output sockets are correspondingly connected to the first to sixth wire connectors of the connector, a voltage between two power input terminals of each output sockets is approximately equal to 230V.

16. The power distribution unit of claim 4, wherein the first connecting ports of the first, the third and the fifth wire connectors of the first interface are respectively connected to a live wire, a neutral wire and a ground wire of a single-phase three-wire power.

17. The power distribution unit of claim 16, wherein the wire circuit comprises a first input port and a second input port arranged in that order in row at one side of the wire circuit, the wire circuit further comprises a first output port, a second output port, a third output port, a fourth output port, a fifth output port, and a sixth output port arranged in that order in row at the other side of the first wire circuit, wherein the first input port is connected to the first, the second and the third output ports, the second input port is connected to the fourth, the third and the fourth output ports, the first input port is connected to the second connecting port of the first wire connector of the second interface, the second input port is connected to the second connecting port of the third wire connector of the second interface.

18. The power distribution unit of claim 17, wherein the connector comprises a first wire connector, a second wire connector, a third wire connector, a fourth wire connector, a fifth wire connector, and a sixth wire connector arranged in that order and electrically insulated from each other, each wire connector of the connector comprises a first connecting port and a second connecting port electrically connected the first connecting port.

19. The power distribution unit of claim 18, wherein the first connecting ports of the connector are respectively connected to the first output port, the second output port, the third output port, the fourth output port, the fifth output port, and the sixth output port of the wire circuit.

20. The power distribution unit of claim 19, wherein each socket comprises two power input terminals, the plurality of output sockets are correspondingly connected to the first to sixth wire connectors of the connector, a voltage between two power input terminals of each output sockets is approximately equal to 220V.
